(19) United States
(12) Patent Application Publication
(10) Pub. No.: US 2019/0274053 A1
(43) Pub. Date: Sep. 5, 2019

(54) Apparatus and Method for Configuring Dynamic Time Division Duplex and Communication System

(71) Applicant: FUJITSU LIMITED, Kawasaki-shi (JP)

(72) Inventors: Weiwei WANG, Beijing (CN); Hua ZHOU, Beijing (CN); Xin WANG, Beijing (CN)

(73) Assignee: FUJITSU LIMITED, Kawasaki-shi (JP)

(21) Appl. No.: 16/418,626

(22) Filed: May 21, 2019

Related U.S. Application Data
(63) Continuation of application No. PCT/CN2016/113609, filed on Dec. 30, 2016.

(51) Int. Cl. H04W 16/10; H04W 72/04; H04W 72/08

(52) U.S. Cl. CPC H04W 16/10; H04W 72/085; H04W 72/0446

(57) ABSTRACT

An apparatus and method for configuring dynamic time division duplex and a communication system. The method includes: receiving, by a network device, strength indication information transmitted by one or more user equipments when strength of a received signal is greater than a first threshold and/or strength of cross-link interference is less than a second threshold; and configuring one or more user equipments within a serving cell as using dynamic time division duplex according to the strength indication information. Hence, a distance between user equipments performing dynamic TDD of neighboring cells is relatively large, thereby efficiently suppressing cross-link interference of a dynamic TDD system.

### CROSS REFERENCE TO RELATED APPLICATIONS

This application is a continuation application of International Application PCT/CN2016/113609 filed on Dec. 30, 2016, the entire contents of which are incorporated herein by reference.

### TECHNICAL FIELD

This disclosure relates to the field of communication technologies, and in particular to an apparatus and method for configuring dynamic time division duplex (TDD) and a communication system.

### BACKGROUND

In a new radio (NR) system, dynamic time division duplex (TDD) supports uplink and downlink configurations dynamically allocating data transmission by taking a time unit (such as a slot) as a basic unit. Hence, each transmission direction between a network device (such as a gNB) and a user equipment may possibly be changed dynamically by taking a time unit (such as a slot) as a basic unit.

FIG. 1 is a schematic diagram of a transmission direction of dynamic TDD. As shown in FIG. 1, at a certain time unit (such as a first slot), a data transmission direction of a network device is a downlink (DL), and at a next time unit (such as a second slot), the data transmission direction of the network device may possibly become into an uplink (UL).

If dynamic TDD is adopted in the NR system, the data transmission direction needs to be changed frequently, which may cause severe cross-link interference (CLI) between neighboring cells.

FIG. 2 is a schematic diagram of use of the dynamic TDD in the NR system. As shown in FIG. 2, in a certain slot, for example, a network device gNB1 uses the dynamic TDD to transmit downlink data to a user equipment UE1 in a local cell (cell 1), and a user equipment UE2 of a serving cell (cell 2) uses the dynamic TDD to transmit uplink data to a network device gNB2; crosslink interference may be generated between UE1 and UE2, and crosslink interference may also be generated between gNB1 and gNB2.

In order to reduce crosslink interference, network devices need to coordinate with each other. For example, if gNB2 knows that the transmission direction between gNB1 and UE1 in the slot is of downlink, a transmission direction between gNB2 and UE2 may also be scheduled to be of downlink or no data transmission is performed, thereby reducing crosslink interference.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

However, it was found by the inventors that very large overhead is needed in coordination between network devices, which is limited by delay of a backhaul between the network devices.

For example, if dynamic TDD is adopted, uplink and downlink transmission directions of a slot are configured by the network device only at one or more symbols preceding the slot (or a slot preceding the slot). If information (such as information of transmission directions) is exchanged via a backhaul in conventional manner, the information is hard to be notified to neighboring network devices in a short time, as delay of a non-ideal backhaul is relatively large.

Embodiments of this disclosure provide an apparatus and method for configuring dynamic time division duplex and a communication system, in which a cell may be semi-persistently divided into a dynamic TDD area and a static TDD area, thereby efficiently suppressing cross-link interference of a dynamic TDD system.

According to a first aspect of the embodiments of this disclosure, there is provided a method for configuring dynamic time division duplex, including:

receiving, by a network device, strength indication information; the strength indication information being transmitted by one or more user equipments when strength of a received signal is greater than a first threshold and/or strength of cross-link interference is less than a second threshold; and configuring one or more user equipments within a serving cell by the network device as using dynamic time division duplex according to the strength indication information.

According to a second aspect of the embodiments of this disclosure, there is provided an apparatus for configuring dynamic time division duplex, including:

a strength indication receiving unit configured to receive strength indication information; the strength indication information being transmitted by one or more user equipments when strength of a received signal is greater than a first threshold and/or strength of cross-link interference is less than a second threshold; and

a resource configuring unit configured to configure one or more user equipments within a serving cell as using dynamic time division duplex according to the strength indication information.

According to a third aspect of the embodiments of this disclosure, there is provided a method for configuring dynamic time division duplex, including:

performing measurement of cross-link interference and/or measurement of a received signal by a user equipment;

transmitting strength indication information by the user equipment to a network device when strength of the received signal is greater than a first threshold and/or strength of the cross-link interference is less than a second threshold; and

determining by the user equipment that it is configured by the network device as using dynamic time division duplex to perform data transmission.

According to a fourth aspect of the embodiments of this disclosure, there is provided an apparatus for configuring dynamic time division duplex, including:

a measuring unit configured to perform measurement of cross-link interference and/or measurement of a received signal;

a strength indication transmitting unit configured to transmit strength indication information to a network device when strength of the received signal is greater than a first threshold and/or strength of the cross-link interference is less than a second threshold; and

a resource determining unit configured to determine that a user equipment is configured by the network device as using dynamic time division duplex to perform data transmission.

According to a fifth aspect of the embodiments of this disclosure, there is provided a communication system, including:

a network device, including the apparatus for configuring dynamic time division duplex as described in the second aspect; and

a user equipment, including the apparatus for configuring dynamic time division duplex as described in the fourth aspect.

An advantage of the embodiments of this disclosure exists in that a user equipment using the dynamic TDD is configured according to the strength indication information, dynamic TDD area may be semi-persistently divided, and different dynamic TDD areas are separated. Hence, a distance between user equipments performing dynamic TDD of neighboring cells is relatively large, thereby efficiently suppressing cross-link interference of a dynamic TDD system.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals assign corresponding parts throughout the several views and may be used to assign like or similar parts in more than one embodiment.

FIG. 1 is a schematic diagram of a transmission direction of dynamic TDD;

FIG. 2 is a schematic diagram of use of dynamic TDD in an NR system;

FIG. 3 is a schematic diagram of a communication system of an embodiment of this disclosure;

FIG. 4 is a schematic diagram of the method for configuring dynamic TDD of Embodiment 1 of this disclosure;

FIG. 5 is a schematic diagram of the dynamic TDD area and the static TDD area of Embodiment 1 of this disclosure;

FIG. 6 is another schematic diagram of the dynamic TDD area and the static TDD area of Embodiment 1 of this disclosure;

FIG. 7 is an exemplary diagram of a dynamic slot of Embodiment 1 of this disclosure;

FIG. 8 is another schematic diagram of the method for configuring dynamic TDD of Embodiment 1 of this disclosure;

FIG. 9 is a schematic diagram of the method for configuring dynamic TDD of Embodiment 2 of this disclosure;

FIG. 10 is a schematic diagram of the apparatus for configuring dynamic TDD of Embodiment 3 of this disclosure;

FIG. 11 is a schematic diagram of the apparatus for configuring dynamic TDD of Embodiment 4 of this disclosure;

FIG. 12 is a schematic diagram of the network device of Embodiment 5 of this disclosure;

and

FIG. 13 is a schematic diagram of the user equipment of Embodiment 5 of this disclosure.

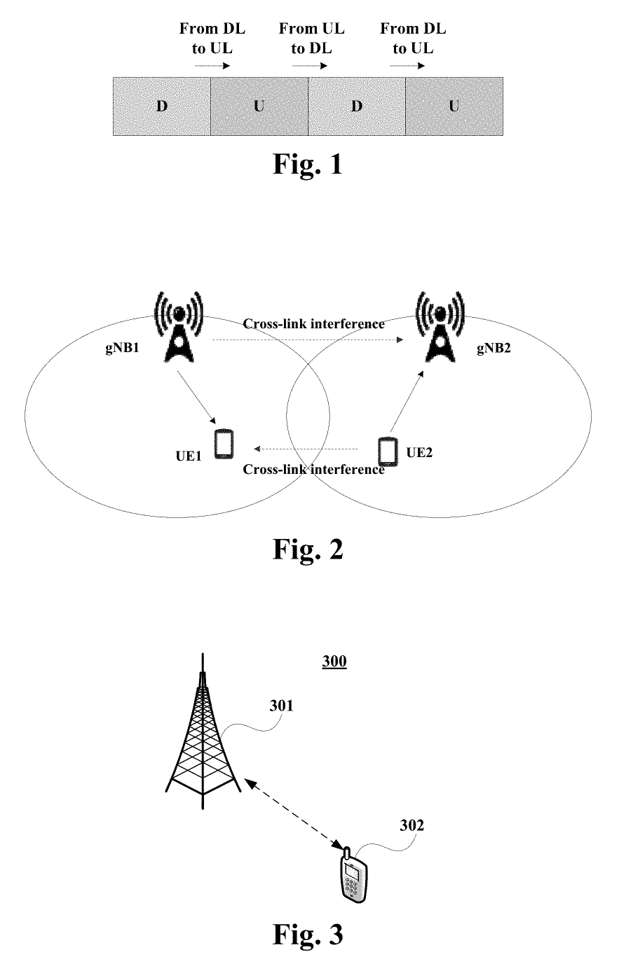

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a terminal device to the communication network and provides services for the terminal device. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, which is dependent on a context of the term.

In the embodiments of this disclosure, the term “user equipment (UE)” or “terminal equipment (TE)” refers to, for example, equipment accessing to a communication network and receiving network services via a network device. The user equipment may be fixed or mobile, and may also be referred to as a mobile station (MS), a terminal, a subscriber station (SS), an access terminal (AT), or a station, etc.

The user equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Scenarios in the embodiments of this disclosure shall be described below by way of examples; however, this disclosure is not limited thereto.

FIG. 3 is a schematic diagram of a communication system of an embodiment of this disclosure, in which a case where a user equipment and a network device are taken as examples is schematically shown. As shown in FIG. 3, the communication system 300 may include a network device 301 and a user equipment 302 (for the sake of simplicity, FIG. 3 shall be described by taking only one user equipment as an example).

In the embodiment of this disclosure, existing traffics or traffics that may be implemented in the future may be performed between the network device 301 and the user equipment 302. For example, such traffics may include but not limited to an enhanced mobile broadband (eMBB), massive machine type communication (mMTC), and ultra-reliable and low-latency communication (URLLC), etc. Dynamic TDD may be adopted between the network device 301 and the user equipment 302 for uplink and downlink data transmission.

The embodiments of this disclosure shall be described below in detail by taking a gNB and a UE as an example.

### Embodiment 1

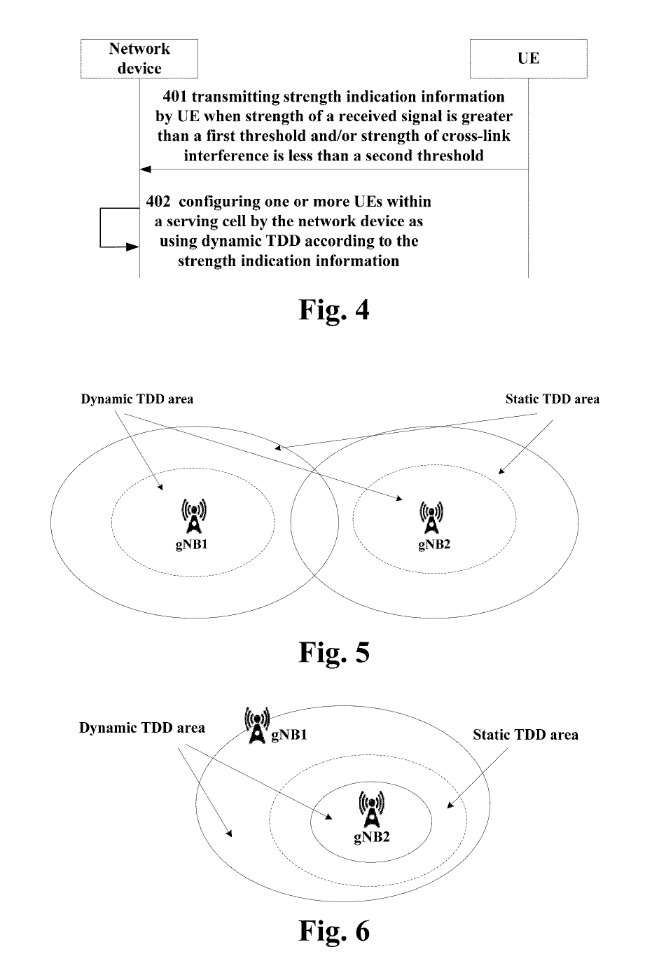

These embodiments of this disclosure provide a method for configuring dynamic time division duplex, applicable to a network device. FIG. 4 is a schematic diagram of the method for configuring dynamic TDD of the embodiment of this disclosure. As shown in FIG. 4, the method includes:

401: the network device receives strength indication information; the strength indication information being transmitted by one or more user equipments when strength of a received signal is greater than a first threshold and/or strength of cross-link interference is less than a second threshold; and

402: the network device configures one or more user equipments within a serving cell as using dynamic time division duplex according to the strength indication information.

In an embodiment, an area formed by one or more user equipments in the serving cell using the dynamic TDD is referred to as a dynamic TDD area. By configuring the user equipments using the dynamic TDD according to the strength indication information, the dynamic TDD area may be divided semi-persistently, and different dynamic TDD areas may be separated.

For example, there exists a static TDD area between the dynamic TDD area of the serving cell and a dynamic TDD of a neighboring cell; user equipments in the static TDD area are served in a static TDD manner, that is, uplink and downlink configurations in a slot shall not be dynamically changed.

FIG. 5 is a schematic diagram of the dynamic TDD area and the static TDD of the embodiment of this disclosure, and FIG. 6 is another schematic diagram of the dynamic TDD area and the static TDD of the embodiment of this disclosure. As shown in FIGS. 5 and 6, a coverage of a cell may be divided into two areas, a static TDD area and a dynamic TDD area; in FIG. 6, the static TDD area may possibly be served by gNB1, or may possibly be served by gNB2.

It should be noted that the dynamic TDD area and the static TDD area referred to in embodiments of this disclosure are not limited to physical areas, and may also be, for example, virtual areas (or may be referred to as sets). That is, an area formed by one or more user equipments using the dynamic TDD may be referred to as a dynamic TDD area, and an area formed by one or more user equipments using the static TDD may be referred to as a static TDD area.

For example, the gNB may divide an area in advance according to a distance or a signal strength, schedule all user equipments in the area to use the dynamic TDD, and schedule all intra-cell user equipments outside the area to use the static TDD; however, this disclosure is not limited thereto.

The case where different dynamic TDD areas are separated is illustrated above by taking the static TDD area as an example. However, this disclosure is not limited thereto; for example, blank areas may be between different dynamic TDD areas, that is, uplink and downlink scheduling of data transmission is not performed.

In an embodiment, the network device may transmit time-domain position information indicating to perform dynamic TDD to the one or more user equipments within the serving cell, so as to configure or schedule the user equipments using the dynamic TDD. However, this disclosure is not limited thereto. And reference may be made to related techniques for how to configure or schedule the dynamic TDD.

In an embodiment, for two different dynamic TDD areas, one user equipment is arbitrarily taken from the two areas respectively, hence, a distance between the two user equipments is relatively large, and even though the two areas use the dynamic TDD, no large interference will be produced between the user equipments. Thus, the network device (e.g., gNB) may dynamically allocate transmission directions (e.g. uplink or downlink) for the user equipments using the dynamic TDD within the dynamic TDD area.

In an embodiment, the network device may configure the user equipments to perform measurement of cross-link interference, and the network device receives information on a result of the measurement of cross-link interference and/or first indication information indicating whether there exists cross-link interference transmitted by the user equipments.

For example, in order to set a suitable dynamic TDD area, the gNB may configure the measurement of cross-link interference for the user equipments, and then the user equipments report the result of measurement. And furthermore, the gNB may configure one or more positions of one or more time-frequency resources of the user equipments for performing the measurement.

If the result of measurement satisfies at least one of the following conditions or a combination of thereof, it shows that the cross-link interference is relatively severe, in which strength of the cross-link interference between the user equipments is greater than a certain threshold, the threshold being, for example, transmitted to the user equipments by the gNB in configuring the measurement of cross-link interference; and a signal to interfere plus noise ratio (SINR) is less than a certain threshold, the threshold being, for example, transmitted to the user equipments by the gNB in configuring the measurement of cross-link interference. However, this disclosure is not limited thereto, and other conditions may also be included.

In an embodiment, the network device may further reconfigure one or more user equipments according to the measurement result information and/or the first indication information, so as to adjust the dynamic time division duplex area.

For example, the gNB may perform adjustment of the dynamic TDD area according to the result of measurement. If the result of measurement shows that the cross-link interference is relatively severe, the gNB may reduce a range of the dynamic TDD area; on the contrary, if the result of measurement shows that the cross-link interference is relatively small, the gNB may expand the range of the dynamic TDD area.

It should be noted that the foregoing reducing the range of the dynamic TDD area may indicate reducing the number of user equipments adopting dynamic TDD; and on the contrary, expanding the range of the dynamic TDD area may indicate increasing the number of user equipments adopting dynamic TDD; however, this disclosure is not limited thereto.

For another example, in addition to reporting the result of measurement, the user equipments may further report the first indication information indicating whether there exists cross-link interference, such as whether there existing an indication message of severe cross-link interference, then the gNB adjusts the dynamic TDD area according to the received indication information.

In an embodiment, the indication information may also be transmitted between network devices; that is, the network device may transmit second indication information indicating whether there exists cross-link interference to the neighboring network device, so that the neighboring network device adjusts a corresponding dynamic time division duplex area.

For example, gNB1 may transmit an indication message of cross-link interference related to the dynamic TDD area, and then gNB2 receiving the indication message may adjust configuration of the corresponding dynamic TDD area.

Table 1 shows an example of adjusting dynamic TDD areas by two gNBs.

TABLE 1

| | | Adjusting dynamic |
|---|---|---|
| gNB1 | gNB2 | TDD areas |
| Receiving indication on | Receiving indication on | Both gNB1 and |
| cross-link interference | cross-link interference | gNB2 reduce TDD |
| from gNB2 | from gNB1 | areas |
| Receiving indication on | Receiving no indication | gNB1 or gNB2 |
| cross-link interference | on cross-link interference | reduces a TDD area |
| from gNB2 | | |
| Receiving no indication | Receiving indication on | gNB1 or gNB2 |
| on cross-link interference | cross-link interference | reduces a TDD area |
| | from gNB1 | |
| Receiving no indication | Receiving no indication | Both gNB1 and |
| on cross-link interference | on cross-link interference | gNB2 expand TDD |
| | | areas |

Here, the indication message may be generated according to at least one of the following conditions or a combination thereof: cross-link interference reported by a user equipment served by the gNB, and the interference is relatively large; the user equipment of the gNB reports an indication message that there exists relatively large cross-link interference; and the gNB discovers that a capacity of the cell or capacities of the user equipments in the dynamic TDD area is/are reduced, and an amount of reduction exceeds a certain threshold. However, this disclosure is not limited thereto, and other conditions may also be included.

In an embodiment, the network device may negotiate one or more time-domain positions for performing dynamic TDD with the neighboring network device.

For example, gNB1 may transmit information to neighboring gNB2, the information containing a position of a slot of gNB1 serving for a serving cell in a dynamic TDD manner (which may be referred to as a dynamic slot), and/or, containing a position of a slot of gNB1 serving for the serving cell in a static TDD manner (which may be referred to as a static slot).

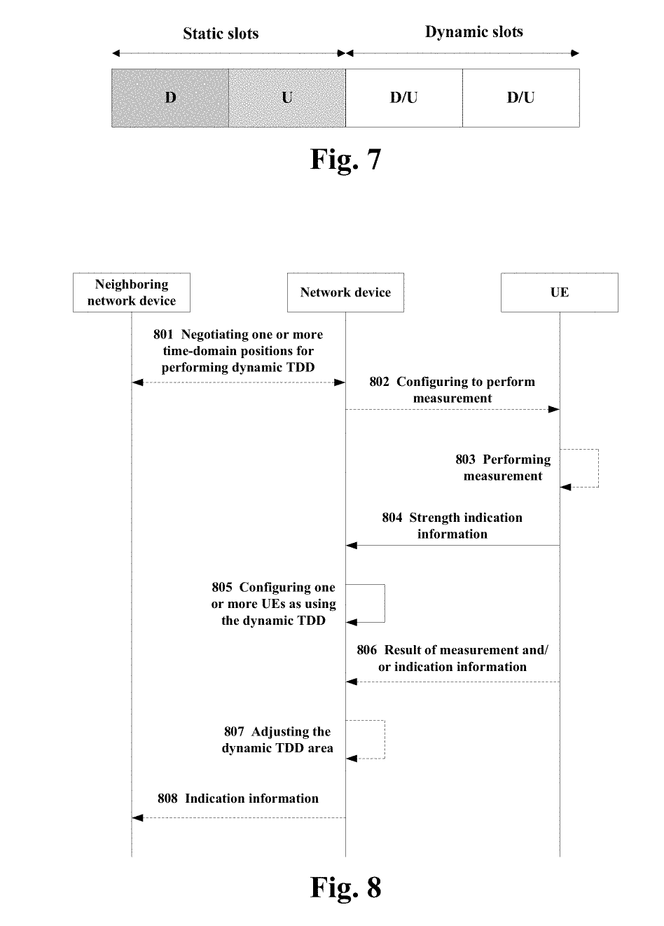

FIG. 7 is an exemplary diagram of the dynamic slot of the embodiment of this disclosure. Taking FIG. 7 as an example, a time period may include four slots, the gNB may use the static TDD at the former two slots (a first and second slots) (applicable to the user equipments in the static TDD area), i.e. DL and UL configurations of the slots are not dynamically changed, and the gNB may use the dynamic TDD at the latter two slots (a third and fourth slots) (applicable to the user equipments in the dynamic TDD area).

For example, gNB1 will transmit a message to neighboring gNB2 indicating that gNB1 will serve the user equipments in its cell in the third and fourth slots in the dynamic TDD manner. According to this message, gNB2 may use the dynamic TDD at the same slots.

In one embodiment, the network device may transmit to the neighboring network device, third indication information indicating one or more time domain positions for performing dynamic TDD, and furthermore, it may receive acknowledgement information transmitted by the neighboring network device.

For example, gNB1 transmits an indication message to gNB2 indicating a position of a dynamic slot of the gNB1, and then gNB2 may set the same dynamic slot and transmit an acknowledgement message to gNB1.

In another embodiment, the network device may transmit third indication information indicating one or more time-domain positions for performing dynamic time division duplex to the neighboring network device, and receive fourth indication information indicating one or more time-domain positions suggested for performing dynamic time division duplex transmitted by the neighboring network device, and determine one or more time-domain positions for performing dynamic time division duplex according to the third indication information and/or the fourth indication information.

For example, gNB1 transmits an indication message to gNB2 indicating the position of a dynamic slot of the gNB1. If gNB2 has a different configuration, it may transmit a suggested position of a dynamic slot to gNB1, and gNB1 may transmit an acknowledgement message to accept the position of the dynamic slot suggested by gNB2.

For another example, if gNB1 and gNB2 have different configurations of dynamic slot and are unwilling to accept configuration of the other party, the two gNBs may select an intersection of the positions of the dynamic slots of them as a position of the negotiated dynamic slot.

In a further embodiment, the network device may transmit third indication information indicating one or more time-domain positions for performing dynamic time division duplex to the neighboring network device and receive rejection information transmitted by the neighboring network device.

For example, if two gNBs are unable to negotiate a suitable configuration of a dynamic slot, one gNB (gNB1) may transmit a rejection message to another gNB (gNB2), in which case a dynamic TDD mechanism is unable to be adopted for either gNB.

In an embodiment, the network device may also determine user equipments located in the dynamic TDD area. For example, the gNB needs to know which user equipments are in the dynamic TDD area, so that it may know which user equipments the dynamic TDD may be applied to.

In an embodiment, the network device may configure the user equipment to measure a strength of the cross-link interference and/or a strength of the received signal. The user equipment may transmit the strength indication information to the network device if the strength of the received signal is greater than the first threshold and/or the strength of the cross-link interference is less than the second threshold. And the network device may determine a user equipment transmitting the strength indication information as a user equipment in the dynamic TDD area.

For example, the gNB may configure the user equipment to measure a strength of a transmit signal of the gNB (i.e. the received signal of the user equipment). If the strength is greater than a threshold (which may be, for example, configured by the gNB), the user equipment transmits reporting information (which may be indication information indicating that the signal strength of the gNB is greater than the set threshold, or may be a message containing a result of measurement). In this way, the gNB may determine that the user equipment is in the dynamic TDD area.

For another example, the gNB may configure the user equipment to measure the strength of the cross-link interference. If the interference strength is less than a threshold (which may be, for example, configured by the gNB), the user equipment transmits reporting information (which may be indication information indicating that the interference strength is less than the set threshold, or may be a message containing a result of measurement). In this way, the gNB may determine that the user equipment is in the dynamic TDD area.

Furthermore, the gNB may also configure the position of time-frequency resource of the user equipment for performing measurement (such as cross-link interference measurements and/or received signal measurement). The gNB may transmit the configuration information to the user equipment, and after receiving the configuration information, the user equipment may perform cross-link interference measurement and/or received signal measurement on the configured time-frequency resource.

FIG. 8 is another schematic diagram of the method for configuring dynamic TDD of the embodiment of this disclosure. As shown in FIG. 8, the method includes:

801: the network device negotiates one or more time-domain positions for performing dynamic TDD with the neighboring network device.

802: the network device configures the user equipment to perform measurement.

803: the user equipment performs measurement.

For example, the user equipment may perform cross-link interference measurement, or may perform received signal measurement; and it may also transmit strength indication information to the network device when the strength of the received signal is greater than the first threshold and/or the strength of the cross-link interference is less than the second threshold.

804: the network device receives the strength indication information transmitted by the user equipment.

For example, the network device may determine the user equipment transmitting the strength indication information as a user equipment in the dynamic TDD area; however, this disclosure is not limited thereto; for example, M user equipments with a highest signal strength may be selected from N user equipments transmitting the strength indication information (M being less than N), etc.

805: the network device configures one or more user equipments in the serving cell as using the dynamic TDD.

For example, the user equipments in the serving cell configured as performing the dynamic TDD form a dynamic TDD area.

806: the network device receives a result of measurement of cross-link interference and/or indication information reported by the user equipment.

For example, the user equipment may perform the measurement of cross-link interference according to the configuration in operation 802 and report the result of measurement; or the user equipment may not report the result of measurement, and report the indication information only when the cross-link interference is relatively severe, to indicate that there exists relatively severe cross-link interference.

807: the network device adjusts the dynamic TDD area.

For example, the network device may reduce the dynamic TDD area when the cross-link interference is relatively severe, and maintain or expand the dynamic TDD area when the cross-link interference is not severe or is relatively small; and

808: the network device transmits indication information to the neighboring network device, so that the neighboring network device adjusts a corresponding dynamic TDD area.

It should be noted that the embodiment of this disclosure is only illustrated in FIG. 8; however, this disclosure is not limited thereto. For example, an order of execution of the operations may be appropriately adjusted; and furthermore, some other operations may be added, or some of these operations may be reduced. And appropriate variants may be made by those skilled in the art according to what is described above, without being limited to the disclosure contained in FIG. 8.

It can be seen from the above embodiments that the user equipment using the dynamic TDD is configured according to the strength indication information, dynamic TDD area may be semi-persistently divided, and different dynamic TDD areas are separated. Hence, a distance between user equipments performing dynamic TDD of neighboring cells is relatively large, thereby efficiently suppressing cross-link interference of a dynamic TDD system.

### Embodiment 2

These embodiments of this disclosure provide a method for configuring dynamic time division duplex, applicable to a user equipment, with contents identical those in Embodiment 1 being not going to be described herein any further.

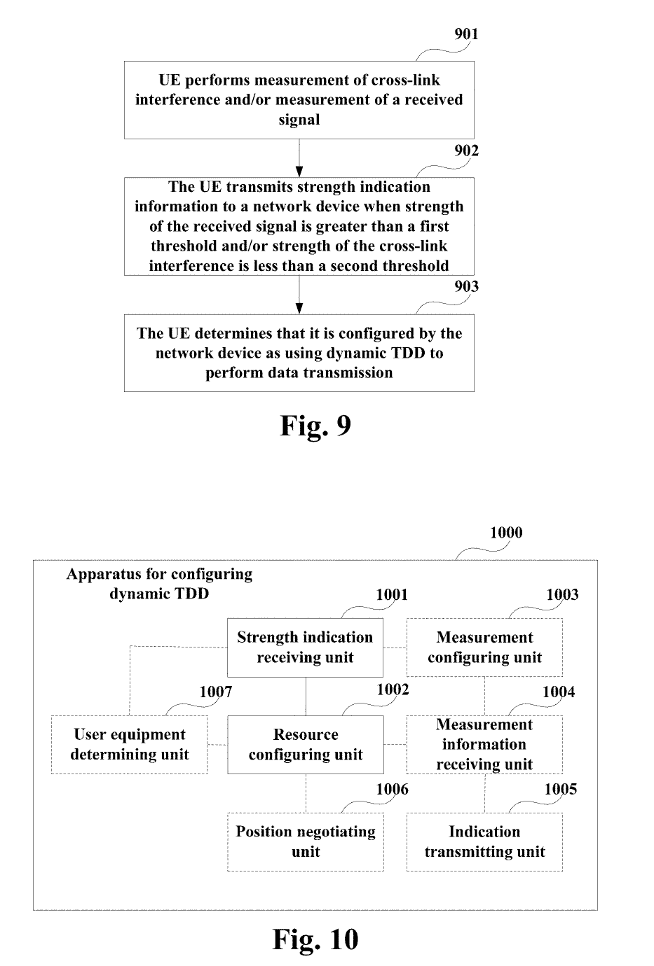

FIG. 9 is a schematic diagram of the method for configuring dynamic TDD of the embodiment of this disclosure. As shown in FIG. 9, the method includes:

901: the user equipment performs measurement of cross-link interference and/or measurement of a received signal.

902: the user equipment transmits strength indication information to a network device when strength of the received signal is greater than a first threshold and/or strength of the cross-link interference is less than a second threshold; and

903: the user equipment determines that it is configured by the network device as using dynamic time division duplex to perform data transmission.

In an embodiment, an area formed by one or more user equipments in the serving cell using the dynamic TDD is referred to as a dynamic TDD area. By configuring the user equipments using the dynamic TDD according to the strength indication information, the dynamic TDD area may be divided semi-persistently, and different dynamic TDD areas may be separated. For example, there exists a static TDD area between the dynamic TDD area of the serving cell and a dynamic TDD of a neighboring cell.

In an embodiment, the user equipment may receive configuration information for performing the measurement of cross-link interference and/or the measurement of the received signal transmitted by the network device, and transmit information on a result of the measurement of cross-link interference and/or first indication information indicating whether there exists cross-link interference to the network device.

In an embodiment, the user equipment may receive time-domain position information indicating to perform dynamic time division duplex transmitted by the network device, thereby determining to perform data transmission by using the dynamic TDD.

It can be seen from the above embodiments that the user equipment using the dynamic TDD is configured according to the strength indication information, dynamic TDD area may be semi-persistently divided, and different dynamic TDD areas are separated. Hence, a distance between user equipments performing dynamic TDD of neighboring cells is relatively large, thereby efficiently suppressing cross-link interference of a dynamic TDD system.

### Embodiment 3

These embodiments of this disclosure provide an apparatus for configuring dynamic TDD, which may be, for example, a network device, or may be one or more parts or components configured in a network device. And contents in these embodiments identical to those in Embodiment 1 shall not be described herein any further.

FIG. 10 is a schematic diagram of the apparatus for configuring dynamic TDD of the embodiment of this disclosure. As shown in FIG. 10, the apparatus 1000 for configuring dynamic TDD includes:

a strength indication receiving unit 1001 configured to receive strength indication information; the strength indication information being transmitted by one or more user equipments when strength of a received signal is greater than a first threshold and/or strength of cross-link interference is less than a second threshold; and

a resource configuring unit 1002 configured to configure one or more user equipments within a serving cell as using dynamic time division duplex according to the strength indication information.

In an embodiment, an area formed by the user equipments within the serving cell using the dynamic time division duplex is referred to as a dynamic time division duplex area. The user equipment using the dynamic TDD is configured according to the strength indication information, dynamic TDD area may be semi-persistently divided, and different dynamic TDD areas are separated. For example, there exists a static TDD area between the dynamic TDD area of the serving cell and a dynamic TDD of a neighboring cell.

In an embodiment, the resource configuring unit 1002 may particularly be configured to transmit time-domain position information indicating to perform dynamic time division duplex to the one or more user equipments within the serving cell.

As shown in FIG. 10, the apparatus 1000 for configuring dynamic TDD may further include:

a measurement configuring unit 1003 configured to configure the one or more user equipments to perform measurement of cross-link interference and/or measurement of the received signal.

As shown in FIG. 10, the apparatus 1000 for configuring dynamic TDD may further include:

a measurement information receiving unit 1004 configured to receive information on a result of the measurement of cross-link interference and/or first indication information indicating whether there exists cross-link interference transmitted by the one or more user equipments.

The resource configuring unit 1002 may further be configured to reconfigure one or more user equipments according to the information on a result of the measurement and/or the first indication information, so as to adjust the dynamic time division duplex area.

As shown in FIG. 10, the apparatus 1000 for configuring dynamic TDD may further include: an indication transmitting unit 1005 configured to transmit second indication information indicating whether there exists cross-link interference to a neighboring network device, so that the neighboring network device adjusts a corresponding dynamic time division duplex area.

As shown in FIG. 10, the apparatus 1000 for configuring dynamic TDD may further include:

a position negotiating unit 1006 configured to negotiate one or more time-domain positions for performing dynamic time division duplex with the neighboring network device.

For example, the position negotiating unit 1006 may transmit third indication information indicating the one or more time-domain positions for performing dynamic time division duplex to the neighboring network device;

or the position negotiating unit 1006 may transmit third indication information indicating the one or more time-domain positions for performing dynamic time division duplex to the neighboring network device and receive acknowledgement information transmitted by the neighboring network device;

or the position negotiating unit 1006 may transmit third indication information indicating the one or more time-domain positions for performing dynamic time division duplex to the neighboring network device, receive fourth indication information indicating one or more time-domain positions suggested for performing dynamic time division duplex transmitted by the neighboring network device, and determine one or more time-domain positions for performing dynamic time division duplex according to the third indication information and/or the fourth indication information;

or the position negotiating unit 1006 may transmit third indication information indicating the one or more time-domain positions for performing dynamic time division duplex to the neighboring network device and receive rejection information transmitted by the neighboring network device.

As shown in FIG. 10, the apparatus 1000 for configuring dynamic TDD may further include:

a user equipment determining unit 1007 configured to determine a user equipment transmitting the strength indication information as a user equipment located in the dynamic time division duplex area.

It should be noted that the components or modules related to this disclosure are only illustrated above; however, this disclosure is not limited thereto. And the apparatus 1000 for configuring dynamic TDD may further include other components or modules, and reference may be made to related techniques for particular contents of these components or modules.

It can be seen from the above embodiments that the user equipment using the dynamic TDD is configured according to the strength indication information, dynamic TDD area may be semi-persistently divided, and different dynamic TDD areas are separated. Hence, a distance between user equipments performing dynamic TDD of neighboring cells is relatively large, thereby efficiently suppressing cross-link interference of a dynamic TDD system.

### Embodiment 4

These embodiments of this disclosure provide an apparatus for configuring dynamic TDD, which may be, for example, a user equipment, or may be one or more parts or components configured in a user equipment. And contents in these embodiments identical to those in embodiments 1 and 2 shall not be described herein any further.

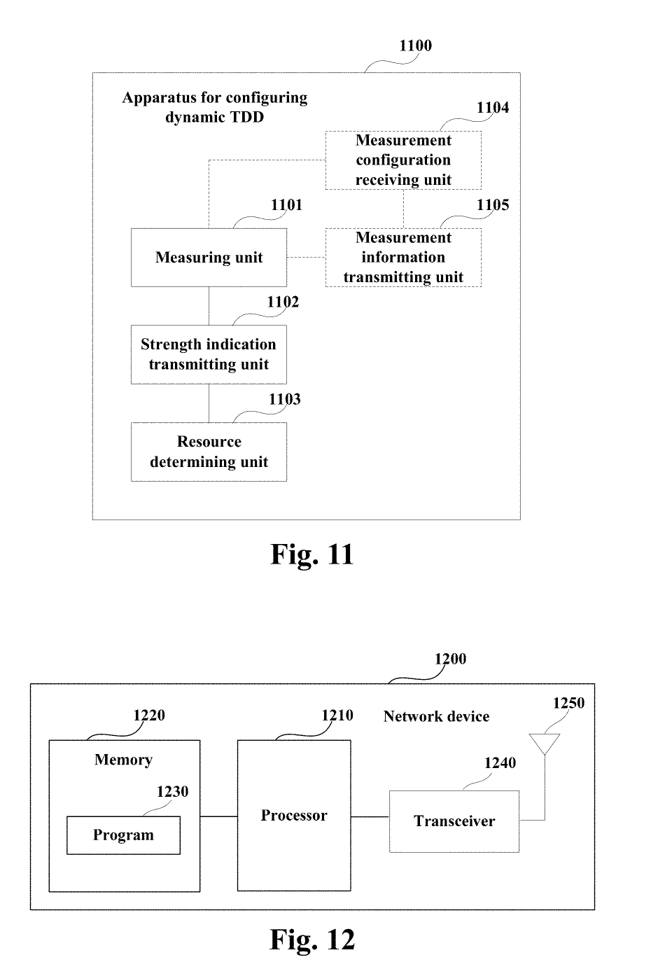

FIG. 11 is a schematic diagram of the apparatus for configuring dynamic TDD of the embodiment of this disclosure. As shown in FIG. 11, the apparatus 1100 for configuring dynamic TDD includes:

a measuring unit 1101 configured to perform measurement of cross-link interference and/or measurement of a received signal;

a strength indication transmitting unit 1102 configured to transmit strength indication information to a network device when strength of the received signal is greater than a first threshold and/or strength of the cross-link interference is less than a second threshold; and

a resource determining unit 1103 configured to determine that it is configured by the network device as using dynamic time division duplex to perform data transmission.

In an embodiment, an area formed by the user equipments within the serving cell using the dynamic time division duplex is referred to as a dynamic time division duplex area. The user equipment using the dynamic TDD is configured according to the strength indication information, dynamic TDD area may be semi-persistently divided, and different dynamic TDD areas are separated. For example, there exists a static TDD area between the dynamic TDD area of the serving cell and a dynamic TDD area of a neighboring cell.

In an embodiment, the resource determining unit 1103 may particularly be configured to receive time-domain position information indicating to perform dynamic time division duplex transmitted by the network device.

As shown in FIG. 11, the apparatus 1100 for configuring dynamic TDD may further include:

a measurement configuration receiving unit 1104 configured to receive configuration information for performing the measurement of cross-link interference and/or the measurement of the received signal transmitted by the network device.

As shown in FIG. 11, the apparatus 1100 for configuring dynamic TDD may further include:

a measurement information transmitting unit 1105 configured to transmit information on a result of the measurement of cross-link interference and/or first indication information indicating whether there exists cross-link interference to the network device.

It should be noted that the components or modules related to this disclosure are only illustrated above; however, this disclosure is not limited thereto. And the apparatus 1100 for configuring dynamic TDD may further include other components or modules, and reference may be made to related techniques for particular contents of these components or modules.

It can be seen from the above embodiments that the user equipment using the dynamic TDD is configured according to the strength indication information, dynamic TDD area may be semi-persistently divided, and different dynamic TDD areas are separated. Hence, a distance between user equipments performing dynamic TDD of neighboring cells is relatively large, thereby efficiently suppressing cross-link interference of a dynamic TDD system.

### Embodiment 5

These embodiments of this disclosure provide a communication system, reference being able to be made to FIG. 3, and contents identical to those in embodiments 1-4 being not going to be described herein any further. In an embodiment, the communication system 300 may include:

a network device 301 configured with the apparatus 1000 for configuring dynamic TDD as described in Embodiment 3; and

a user equipment 302 configured with the apparatus 1100 for configuring dynamic TDD as described in Embodiment 4.

The embodiment of this disclosure further provides a network device, such as a base station; however, this disclosure is not limited thereto, and may also be other network devices.

FIG. 12 is a schematic diagram of a structure of the network device of the embodiment of this disclosure. As shown in FIG. 12, the network device 1200 may include a processor 1210 (such as a central processing unit (CPU)) and a memory 1220, the memory 1220 being coupled to the processor 1210. The memory 1220 may store various data, and furthermore, it may store a program 1230 for data processing, and execute the program 1230 under control of the processor 1210.

The processor 1210 may be configured to execute the functions of the apparatus 1000 for configuring dynamic TDD. For example, the processor 1210 may be configured to execute the program 1230 to perform the following control: receiving strength indication information; the strength indication information being transmitted by one or more user equipments when strength of a received signal is greater than a first threshold and/or strength of cross-link interference is less than a second threshold; and configuring one or more user equipments within a serving cell as using dynamic time division duplex according to the strength indication information.

Furthermore, as shown in FIG. 12, the network device 1200 may include a transceiver 1240, and an antenna 1250, etc. Functions of the above components are similar to those in the relevant art, and shall not be described herein any further. It should be noted that the network device 1200 does not necessarily include all the parts shown in FIG. 12, and furthermore, the network device 1200 may include parts not shown in FIG. 12, and the relevant art may be referred to.

The embodiment of this disclosure further provides a user equipment; however, this disclosure is not limited thereto, and may also be other devices.

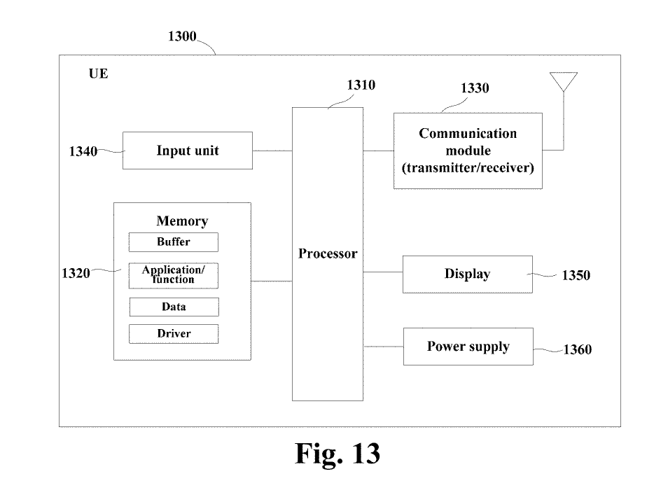

FIG. 13 is a schematic diagram of the user equipment of the embodiment of this disclosure. As shown in FIG. 13, the user equipment 1300 may include a processor 1310 and a memory 1320, the memory 1320 storing data and programs and being coupled to the processor 1310. It should be noted that this figure is illustrative only, and other types of structures may also be used, so as to supplement or replace this structure and achieve a telecommunications function or other functions.

The processor 1310 may be configured to execute the functions of the apparatus 1100 for configuring dynamic TDD. For example, the processor 1310 may be configured to perform the following control: performing measurement of cross-link interference and/or measurement of a received signal; transmitting strength indication information to a network device when strength of the received signal is greater than a first threshold and/or strength of the cross-link interference is less than a second threshold; and determining that it is configured by the network device as using dynamic time division duplex to perform data transmission.

As shown in FIG. 13, the user equipment 1300 may further include a communication module 1330, an input unit 1340, a display 1350 and a power supply 1360. Functions of the above components are similar to those in the relevant art, and shall not be described herein any further. It should be noted that the user equipment 1300 does not necessarily include all the parts shown in FIG. 13, and the above components are not necessary; and furthermore, the user equipment 1300 may include parts not shown in FIG. 13, and the relevant art may be referred to.

An embodiment of the present disclosure provides a computer readable program code, which, when executed in a network device (such as a base station), will cause the network device (such as a base station) to carry out the method for configuring dynamic TDD as described in Embodiment 1.

An embodiment of the present disclosure provides a computer readable medium, including a computer readable program code, which will a network device (such as a base station) to carry out the method for configuring dynamic TDD as described in Embodiment 1.

An embodiment of the present disclosure provides a computer readable program code, which, when executed in a user equipment, will cause the user equipment to carry out the method for configuring dynamic TDD as described in Embodiment 2.

An embodiment of the present disclosure provides a computer readable medium, including a computer readable program code, which will cause a user equipment to carry out the method for configuring dynamic TDD as described in Embodiment 2.

The above apparatuses of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or operations as described above. The present disclosure also relates to a storage medium for storing the above program, such as a hard disk, a floppy disk, a CD, a DVD, and a flash memory, etc.

The method/apparatus described with reference to the embodiments of this disclosure may be directly embodied as hardware, software modules executed by a processor, or a combination thereof. For example, one or more functional block diagrams and/or one or more combinations of the functional block diagrams shown in FIG. 10 may either correspond to software modules of procedures of a computer program, or correspond to hardware modules. Such software modules may respectively correspond to the operations shown in FIG. 4. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the accompanying drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the accompanying drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. An apparatus for configuring dynamic time division duplex, comprising:
a memory that stores a plurality of instructions; and
a processor coupled to the memory and configured to execute the instructions to:
receive strength indication information; the strength indication information being transmitted by one or more user equipments when strength of a received signal is greater than a first threshold and/or strength of cross-link interference is less than a second threshold; and
configure one or more user equipments within a serving cell as using dynamic time division duplex.

2. The apparatus according to claim 1, wherein an area formed by the user equipments within the serving cell using the dynamic time division duplex is a dynamic time division duplex area.

3. The apparatus according to claim 2, wherein there exists a static time division duplex area between the dynamic time division duplex area of the serving cell and a dynamic time division duplex area of a neighboring cell.

4. The apparatus according to claim 1, wherein the processor is configured to transmit time-domain position information indicating to perform dynamic time division duplex to one or more user equipments within the serving cell.

5. The apparatus according to claim 1, wherein the processor is further configured to configure the one or more user equipments to perform measurement of cross-link interference and/or measurement of the received signal.

6. The apparatus according to claim 1, wherein the processor is further configured to receive information on a result of the measurement of cross-link interference and/or first indication information indicating whether there exists cross-link interference transmitted by the one or more user equipments.

7. The apparatus according to claim 6, wherein the processor is further configured to reconfigure one or more user equipments according to the information on a result of the measurement and/or the first indication information, to adjust the dynamic time division duplex area.

8. The apparatus according to claim 6, wherein the processor is further configured to transmit second indication information indicating whether there exists cross-link interference to a neighboring network device, the second indication information is used by the neighboring network device to adjust a corresponding dynamic time division duplex area.

9. The apparatus according to claim 1, wherein the processor is further configured to negotiate one or more time-domain positions for performing dynamic time division duplex with the neighboring network device.

10. The apparatus according to claim 9, wherein the processor is configured to transmit third indication information indicating the one or more time-domain positions for performing dynamic time division duplex to the neighboring network device;
or to transmit third indication information indicating the one or more time-domain positions for performing dynamic time division duplex to the neighboring network device and receive acknowledgement information transmitted by the neighboring network device;
or to transmit third indication information indicating the one or more time-domain positions for performing dynamic time division duplex to the neighboring network device, receive fourth indication information indicating one or more time-domain positions suggested for performing dynamic time division duplex transmitted by the neighboring network device, and determine one or more time-domain positions for performing dynamic time division duplex according to the third indication information and/or the fourth indication information;
or to transmit third indication information indicating the one or more time-domain positions for performing dynamic time division duplex to the neighboring network device and receive rejection information transmitted by the neighboring network device.

11. The apparatus according to claim 1, wherein the processor is further configured to determine a user equipment transmitting the strength indication information as a user equipment located in the dynamic time division duplex area.

12. An apparatus for configuring dynamic time division duplex, comprising:
a memory that stores a plurality of instructions; and
a processor coupled to the memory and configured to execute the instructions to:
perform measurement of cross-link interference and/or measurement of a received signal;
transmit strength indication information to a network device when strength of the received signal is greater than a first threshold and/or strength of the cross-link interference is less than a second threshold; and
determine that a user equipment is configured by the network device as using dynamic time division duplex to perform data transmission.

13. The apparatus according to claim 12, wherein an area formed by one or more user equipments within a serving cell using the dynamic time division duplex is a dynamic time division duplex area.

14. The apparatus according to claim 13, wherein there exists a static time division duplex area between the dynamic time division duplex area of the serving cell and a dynamic time division duplex area of a neighboring cell.

15. The apparatus according to claim 12, wherein the processor is configured to receive time-domain position information indicating to perform dynamic time division duplex transmitted by the network device.

16. The apparatus according to claim 12, wherein the processor is further configured to receive configuration information for performing the measurement of cross-link interference and/or the measurement of the received signal transmitted by the network device.

17. The apparatus according to claim 12, wherein the processor is further configured to transmit information on a result of the measurement of cross-link interference and/or first indication information indicating whether there exists cross-link interference to the network device.

18. A communication system, comprising:
a network device, configured to receive strength indication information; and configure one or more user equipments within a serving cell as using dynamic time division duplex; and
a user equipment, configured to perform measurement of cross-link interference and/or measurement of a received signal; transmit the strength indication information when strength of the received signal is greater than a first threshold and/or strength of the cross-link interference is less than a second threshold; and determine that the user equipment is configured by the network device as using dynamic time division duplex to perform data transmission.
